(19) United States
(12) Patent Application Publication
(10) Pub. No.: US 2024/0311686 A1
(43) Pub. Date: Sep. 19, 2024

(54) MODEL COMPILING METHOD AND APPARATUS, AND MODEL RUNNING SYSTEM

(71) Applicant: SHENZHEN CORERAIN TECHNOLOGIES CO., LTD., Guangdong (CN)

(72) Inventors: Jiongkai HUANG, Shenzhen (CN); Kuen-Hung TSOI, Shenzhen (CN); Xinyu NIU, Shenzhen (CN)

(73) Assignee: SHENZHEN CORERAIN TECHNOLOGIES CO., LTD., Shenzhen (CN)

(21) Appl. No.: 18/263,570

(22) PCT Filed: Aug. 31, 2022
(86) PCT No.: PCT/CN2022/116199

§ 371 Date: Jul. 31, 2023

(30) Foreign Application Priority Data
Oct. 25, 2021 (CN) 202111240278.2

(51) Int. Cl. G06N 20/00

(52) U.S. Cl. CPC G06N 20/00

(57) ABSTRACT

A model compiling method and apparatus, and a model running system. The method includes: parsing a model file to obtain a first computational graph; determining runtime information of a first set of first operators according to a user input and the first computational graph; determining hardware configuration information of a first operator according to the runtime information of each first operator in the first set of first operators; and sending the hardware configuration information of the first operator to an execution device to cause the execution device to perform computation of the first operator.

### CROSS-REFERENCE TO RELATED APPLICATIONS

This application claims priority to Chinese Patent Application No. 202111240278.2, entitled “MODEL COMPILING METHOD AND APPARATUS, AND MODEL RUNNING SYSTEM”, filed on Oct. 25, 2021, which is incorporated herein by reference in its entirety.

### TECHNICAL FIELD

The present disclosure relates to the technical field of artificial intelligence, and in particular, to a model compiling method and apparatus, and a model running system.

### BACKGROUND

Machine learning models are widely used in the field of artificial intelligence, such as speech recognition, natural language processing, and image recognition and processing. Because the inference process of a machine learning model typically involves a large number of computation tasks and requires high compute power, the machine learning model often needs to be run on an execution device that can process a large number of computation tasks.

In the related art, a machine learning model is usually compiled into instructions of an executable program, and an execution device based on an instruction set is used to execute the instructions of the executable program to run the machine learning model, thereby implementing an inference process of the machine learning model.

### SUMMARY

The methods in the related art have certain limitations in that a streaming-based execution device cannot read instructions of an executable program and consequently cannot run a machine learning model.

In order to solve the above problems, embodiments of the present disclosure propose the following solutions.

According to one aspect of the embodiments of the present disclosure, a model compiling method is provided, which includes: acquiring a model file corresponding to a machine learning model including a plurality of computation layers in response to a running indication; parsing the model file to obtain a first computational graph executable by hardware, where the first computational graph includes a plurality of first operators, and each first operator corresponds to at least one computation layer; determining runtime information of a first set of first operators according to an input from a user and the first computational graph, where the first set of first operators includes at least a subset of the plurality of first operators; determining hardware configuration information corresponding to each first operator in the first set of first operators according to the runtime information of each first operator in the first set of first operators; and sending the hardware configuration information corresponding to each of the plurality of first operators to a streaming-based execution device to cause the execution device to perform computation corresponding to each first operator.

In some embodiments, the parsing further obtains static data required for performing the computation corresponding to each of the plurality of first operators; and determining the runtime information of the first set of first operators according to the input from the user and the first computational graph includes: determining output information of each first operator in the first set of first operators according to the input, the at least one computation layer corresponding to the first operator, and the static data of the first operator, the runtime information of the first operator including the output information of the first operator.

In some embodiments, the plurality of first operators include the first set of first operators and a second set of first operators other than the first set of first operators, and the method further includes: acquiring hardware configuration information corresponding to each first operator in the second set of operators.

In some embodiments, the method further includes: receiving structural information of the machine learning model input by the user, the structural information including types, numbers, and connection manners of the plurality of computation layers; generating a second computational graph corresponding to the machine learning model according to the structural information, the second computational graph including a plurality of second operators one-to-one corresponding to the plurality of computation layers; converting the second computational graph into the first computational graph, each of the plurality of first operators corresponding to at least one second operator; and obtaining the model file according to the first computational graph.

In some embodiments, the structural information further includes layer parameters for each of the plurality of computation layers, and the method further includes: determining static data of the second operator corresponding to each computation layer according to the layer parameters of the computation layer; and obtaining, according to the static data of at least one second operator corresponding to each of the plurality of first operators, static data required for performing the computation corresponding to the first operator; and the obtaining the model file according to the first computational graph includes: serializing the first computational graph and the static data required for performing the computation corresponding to each of the plurality of first operators to obtain the model file.

In some embodiments, at least one of the plurality of first operators corresponds to a plurality of second operators.

In some embodiments, the second computational graph includes a computation sub-graph, and the computation sub-graph is generated in advance based on types, numbers, and connection manners of at least two computation layers.

In some embodiments, the running indication is received via a first application programming interface and the structural information is received via a second application programming interface, and the first application programming interface and the second application programming interface are located in a same user interface.

In some embodiments, the execution device includes an artificial intelligence accelerator.

In some embodiments, the machine learning model is a neural network model.

According to another aspect of the embodiments of the present disclosure, a model compiling apparatus is provided, which includes: a memory; and a processor coupled to the memory, configured to perform the method of any one of the above embodiments based on instructions stored in the memory.

According to yet another aspect of the embodiments of the present disclosure, a model running system is provided, which includes: a compiler, where the compiler includes the model compiling apparatus according to any one of the above embodiments; and an execution device, configured to perform computation corresponding to each first operator by configuring according to hardware configuration information corresponding to each of the plurality of first operators sent by the compiler according to any one of the above embodiments.

In the embodiments of the present disclosure, the hardware configuration information of at least a subset may be determined according to the input from the user and the first computational graph obtained by parsing the model file corresponding to the machine learning model, such that the streaming-based execution device may perform computation corresponding to each first operator according to the hardware configuration information corresponding to each first operator. In this manner, the machine learning model is not compiled into instructions of an executable program, but is compiled into the hardware configuration information corresponding to each first operator in the first computational graph executable by the hardware, and the streaming-based execution device can run the machine learning model by reading the hardware configuration information corresponding to each first operator, thereby overcoming the technical problem that the streaming-based execution device cannot run the machine learning model.

Technical solutions of the present disclosure are described in further detail below with reference to the accompanying drawings and embodiments.

### BRIEF DESCRIPTION OF THE DRAWINGS

In order to explain the embodiments of the present disclosure or the technical solutions in the prior art more clearly, a brief description will be given below to the accompanying drawings which are used in the description of the embodiments or the prior art, and it is obvious that the drawings in the description below are merely some embodiments of the present disclosure, and for a person skilled in the art, other drawings can be obtained according to these drawings without involving any creative effort.

FIG. 1 is a schematic flowchart of a model compiling method according to some embodiments of the present disclosure;

FIG. 2 is a schematic flowchart of a model compiling method according to some other embodiments of the present disclosure;

FIG. 3 is a schematic flowchart of a model compiling method according to still other embodiments of the present disclosure;

FIG. 4 is a schematic structural diagram of a model compiling apparatus according to some embodiments of the present disclosure;

FIG. 5 is a schematic structural diagram of a model compiling apparatus according to some other embodiments of the present disclosure;

FIG. 6 is a schematic structural diagram of a model compiling apparatus according to still other embodiments of the present disclosure; and

FIG. 7 is a schematic structural diagram of a model running system according to some embodiments of the present disclosure.

### DETAILED DESCRIPTION

Technical solutions of embodiments of the present disclosure are described clearly and completely below with reference to the accompanying drawings of the embodiments of the present disclosure. Obviously, the described embodiments are only part of the embodiments of the present disclosure, not the whole embodiments. Based on the embodiments in the present disclosure, all other embodiments obtained by a person skilled in the art without creative efforts shall fall within the protection scope of the present disclosure.

The relative arrangement of parts and steps, numerical expressions and numerical values set forth in these embodiments do not limit the scope of the present disclosure unless specifically stated otherwise.

In addition, it should be understood that the dimensions of the various parts illustrated in the figures are not drawn according to an actual proportional relationship for ease of description.

Techniques, methods, and devices known to a person skilled in the relevant art may not be discussed in detail, but should be considered part of the authorized description where appropriate.

In all examples shown and discussed herein, any particular value should be interpreted as illustrative only and not as limiting. Thus, other examples of exemplary embodiments may have different values.

It should be noted that: like numbers and letters refer to like items in the following figures, and thus, once an item is defined in one figure, further discussion thereof is not required in subsequent figures.

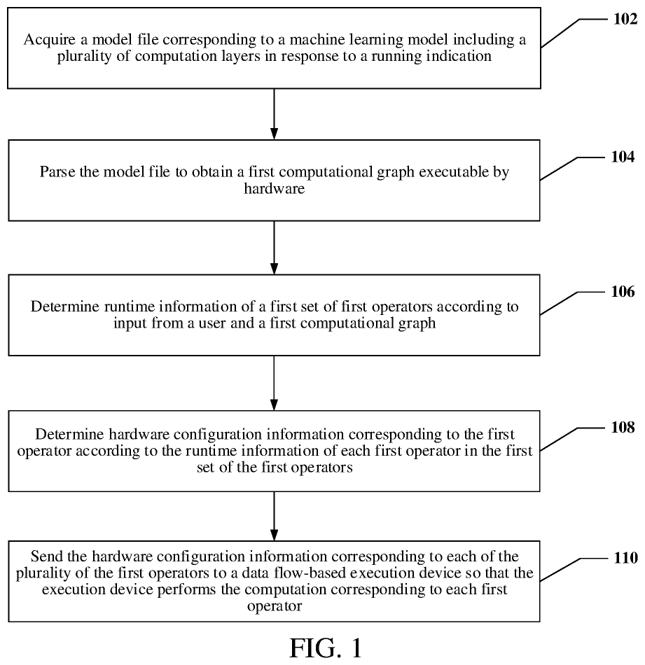

FIG. 1 is a schematic flowchart of a model compiling method according to some embodiments of the present disclosure.

In step 102, a model file corresponding to a machine learning model including a plurality of computation layers is acquired in response to a running indication.

In some embodiments, the running indication input by a user may be received through a first application programming interface. For example, the first application programming interface may be a C++ interface.

In some embodiments, the model file may be a binary file with .bin as a suffix.

In some embodiments, the machine learning model may be a neural network model and the plurality of computation layers may include a convolution layer, a pooling layer, a fully connected layer, etc. in the neural network model.

In step 104, the model file is parsed to obtain a first computational graph executable by hardware. The first computational graph includes a plurality of first operators, each first operator corresponding to at least one computation layer.

In some embodiments, types, numbers, and connection manners of the plurality of first operators executable by the hardware may be obtained according to the first computational graph, where the type of the first operator may be determined according to a computation layer corresponding to each first operator, and the computation order between the first operators may be determined according to the connection manners among the plurality of first operators.

It is to be understood that the computations that need to be performed when the first operator is executed may be determined from at least one computation layer corresponding to each first operator.

In some embodiments, a first operator may correspond to a computation layer, and at this time, performing the computation corresponding to the first operator is equivalent to performing the computation corresponding to the computation layer. For example, if a certain first operator corresponds to a convolution layer, performing the computation corresponding to the first operator is equivalent to performing the computation corresponding to the convolution layer.

In other embodiments, a first operator may correspond to a plurality of computation layers, and at this time, performing the computation corresponding to the first operator is equivalent to performing a plurality of computations corresponding to the plurality of computation layers. For example, if a certain first operator corresponds to a convolution layer and a full connection layer, performing the computation corresponding to the first operator is equivalent to performing the computation corresponding to the convolution layer and the computation corresponding to the full connection layer.

In step 106, the runtime information of a first set of first operators is determined according to input from the user and the first computational graph.

The first set of first operators include at least a subset of the plurality of first operators.

In some embodiments, the runtime information may include input information of each first operator in the first set of first operators. For example, the input information of each first operator may include the size of the input for the first operator. Taking the input information including the size of the input as an example, the size of the input of the first operator in the first computational graph may be determined according to the size of the input from the user, and the size of the input of the other first operator may be determined according to the size of the output of the previous first operator. In some cases, the size of the output of the previous first operator depends only on the type of the previous first operator; and in other cases, the size of the output of the previous first operator depends on the type of the previous first operator and the static data required for performing the computation corresponding to the previous first operator.

For example, the first computational graph may include two first operators A and B, respectively, with the output of A as the input to B. Assuming that the input from the user is an image with a pixel size of 100×100, then the input of A has a size of 100×100; and assuming that the size of the output of A determined according to the first computational graph is 50×50, and the size of the input of B is 50×50.

In some embodiments, the runtime information may include only input information of each first operator in the first set of first operators.

In other embodiments, the runtime information of the first set of first operators may include input information and output information of each first operator in the first set of first operators. The case where the runtime information further includes the output information will be described later in conjunction with various embodiments.

In step 108, hardware configuration information corresponding to the first operator is determined according to the runtime information of each first operator in the first set of first operators.

In some embodiments, the hardware configuration information corresponding to the first operator may include values of configuration parameters required for configuring hardware to perform computation corresponding to the first operator. For example, the runtime information of a certain first operator includes the input size of the first operator 56×56×256, and at this time, the hardware configuration information corresponding to the first operator may include the values of the configuration parameters ih, iw, and ic corresponding to the input size, i.e., ih=56, iw=56, and ic=256. The first 56 of the input sizes 56×56×256 of the first operator represents the size of height of the input, the second 56 represents the size of width of the input, and 256 represents the size of the number of channels of the input.

In step 110, the hardware configuration information corresponding to each of the plurality of first operators is sent to an execution device to cause the execution device to perform the computation corresponding to each first operator.

In some embodiments, the plurality of first operators are identical to the first set of first operators. In this case, the hardware configuration information corresponding to each first operator needs to be dynamically determined according to the input from the user.

In other embodiments, the plurality of first operators may include the first set of first operators and a second set of first operators other than the first set of first operators. In this case, the hardware configuration information of each first operator in the first set of first operators may be determined according to the embodiments in steps 106 and 108, and the hardware configuration information corresponding to each first operator in the second set of first operators may be directly obtained.

In some embodiments, the execution device may include an artificial intelligence (AI) accelerator. For example, the AI accelerator may be an AI scalar accelerator or an AI vector accelerator. In some cases, the computation for each first operator may be performed by a central processing unit (CPU) of the AI accelerator.

In the above embodiments, the hardware configuration information of at least a subset may be determined according to the input from the user and the first computational graph obtained by parsing the model file corresponding to the machine learning model, such that a streaming-based execution device may perform the computation corresponding to each first operator according to the hardware configuration information corresponding to each first operator. In this manner, what obtained after compiling the machine learning model is not the instruction of the executable program, but the hardware configuration information corresponding to each first operator in the first computational graph executable by the hardware; and the streaming-based execution device can run the machine learning model by reading the hardware configuration information corresponding to each first operator, thereby overcoming the technical problem that the streaming-based execution device cannot run the machine learning model.

Further, regardless of the size of the user's input, the runtime information of at least a subset in the first computational graph can be determined directly according to the input from the user and the first computational graph, without additional processing on the user's input, thereby improving the running efficiency of the machine learning model.

In some embodiments, parsing the model file corresponding to the machine learning model in step 104 may further obtain static data required for performing the computations corresponding to each of the plurality of first operators. It is to be understood that for a certain first operator, the static data is invariant. For example, the computation corresponding to performing the first operator may be a convolution computation, and the static data of the first operator may be parameters such as the size, step size and weight of a convolution kernel required for performing the convolution computation.

In some embodiments, the output information of the first operator may be determined according to the input from the user, at least one computation layer corresponding to each first operator in the first set of first operators and the static data of the first operator. The runtime information of the first operator may include the output information of the first operator. For example, the output information of each first operator may include the size of the output of the first operator. Taking the output information including the size of the output as an example, a certain first operator B1 in the first set of first operators may correspond to a convolution layer; assuming that the input from the user is an image of 256×256, according to the computation corresponding to B1 and the static data (such as the size of the convolution kernel, the size of a padding value and the step size, etc.) required for performing the computation corresponding to B1, and the size of the output of B1 may be determined to be 63×63.

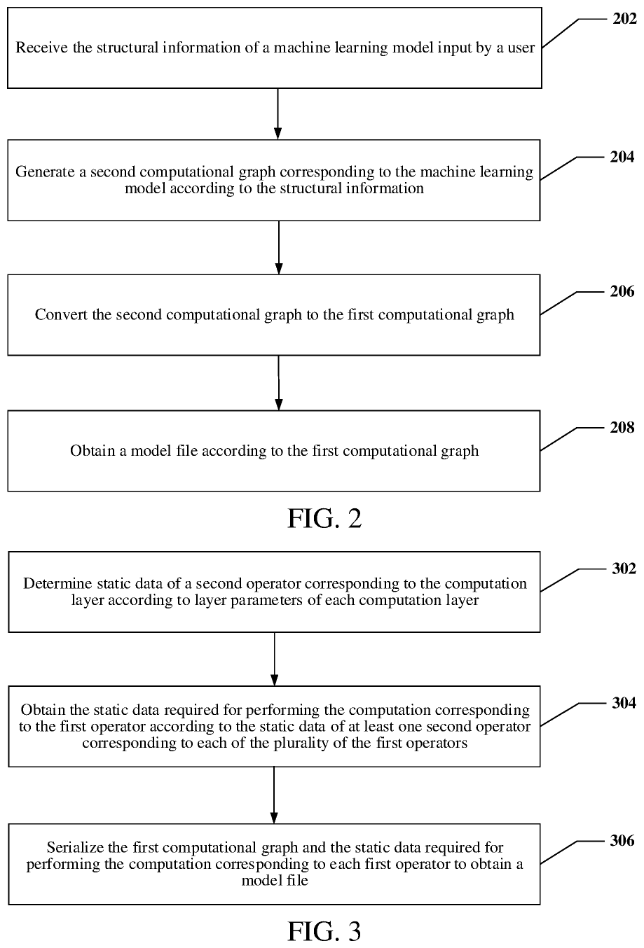

FIG. 2 is a schematic flowchart of a model compiling method according to some other embodiments of the present disclosure.

In some embodiments, the model compiling method further includes steps 202 to 208 shown in FIG. 2 in addition to the steps shown in FIG. 1.

In step 202, the structural information of a machine learning model input by a user is received.

The structural information includes types, numbers and connection manners of a plurality of computation layers.

In some embodiments, the structural information input by the user of the machine learning model may be received through a second application programming interface.

In some embodiments, the first application programming interface and the second application programming interface may reside in the same user interface. In this way, the user can send the structural information and running instructions through the same user interface, reducing the complexity of user operations.

In some embodiments, the machine learning model input by the user may be a neural network model, and at this time, the types of computation layers in the machine learning model may include convolution, pooling, full connection, etc. and the computation order between the computation layers may be determined according to the connection manners among the plurality of computation layers. For example, according to the connection manner between the convolution layer, the pooling layer and the full connection layer in a certain neural network model, it can be determined that the computation order between the computation layers is to firstly calculate the convolution layer, then calculate the pooling layer and finally calculate the full connection layer.

In step 204, a second computational graph corresponding to the machine learning model is generated according to the structural information.

The second computational graph includes a plurality of second operators corresponding to the plurality of computation layers on a one-to-one basis.

In some embodiments, the types, numbers, and connection manners of the plurality of computation layers in the machine learning model may be obtained according to the second computational graph.

In step 206, the second computational graph is converted to the first computational graph.

The first computational graph includes a plurality of first operators, each first operator corresponding to at least one second operator.

In some cases, a first operator may correspond to a second operator. In other cases, a first operator may correspond to a plurality of second operators.

In step 208, a model file is obtained according to the first computational graph.

In some embodiments, the first computational graph may be serialized to obtain a model file corresponding to the machine learning model.

It is to be understood that the structural information of a plurality of machine learning models may be input in advance to obtain a model file corresponding to each machine learning model, so that the model file corresponding to the machine learning model may be obtained in response to a running instruction to operate the machine learning model during operation.

In the above embodiments, in the process of compiling the machine learning model into the model file, the user does not need to input a source code corresponding to the machine learning model, but can directly input structural information of the machine learning model, further reducing the complexity of user operations. In addition, after the model file is obtained, the error in the compilation process can be confirmed by directly viewing the model file, and the search efficiency of the compilation error is improved compared with the method in the related art, which requires hardware to execute the instructions of the executable program to search for the compilation error.

In some embodiments, at least one of the plurality of first operators may correspond to the plurality of second operators. For example, in the process of converting the second computational graph into the first computational graph executable by the hardware, the second operator corresponding to the convolution layer and the second operator corresponding to the pooling layer can be merged into the first operator executable by the hardware according to the execution requirements of the hardware. Thus, in the process of running the machine learning model, executing a computation by the hardware corresponding to the first operator is equivalent to executing a computation corresponding to the plurality of second operators, thereby further improving the running efficiency of the machine learning model.

In some embodiments, the second computational graph may include a computation sub-graph that may be generated in advance based on the types, numbers, and connection manners of at least two computation layers. For example, for some frequently used computation layers, the computation sub-graph can be generated in advance according to the types, numbers and connection manners of the computation layers, so that the corresponding computation sub-graph can be directly called in a case that structural information corresponding to the computation layers is included in the structural information input by the user.

In the above embodiments, by generating the computation sub-graph in advance, the generated computation sub-graph can be directly called in the process of generating the second computational graph, thereby improving the compilation efficiency of the machine learning model.

FIG. 3 is a schematic flowchart of a model compiling method according to still other embodiments of the present disclosure.

In some embodiments, the structural information of the machine learning model input by the user received in step 202 may further include layer parameters for each of a plurality of computation layers.

In this case, the model compiling method further includes steps 302 to 306 shown in FIG. 3 in addition to the steps shown in FIG. 1 and FIG. 2.

In step 302, the static data of a second operator corresponding to the computation layer is determined according to layer parameters of each computation layer.

In some embodiments, the layer parameters for each computation layer may be rearranged according to the execution requirements of the hardware to determine the static data of the second operator corresponding to the computation layer. For example, the layer parameters of the convolution layer include the size of the convolution kernel 50×50×32, and the hardware is an AI accelerator based on a streaming architecture. Since performing the computation corresponding to an operator in an AI accelerator based on the streaming architecture needs to pre-determine the arrangement order of data in a computation module according to the execution requirements of the AI accelerator, the pre-determined arrangement order of data can be an arrangement parameter 32 and then an arrangement parameter 50×50, and further, it can be determined that the static data of the second operator includes 32×50×50.

In step 304, the static data required for performing the computation corresponding to the first operator is obtained according to the static data of at least one second operator corresponding to each of the plurality of first operators.

In some embodiments, a first operator may correspond to a second operator, and at this time, the static data required for performing the computation corresponding to the first operator may be the static data of the second operator. In other embodiments, a first operator may correspond to a plurality of second operators, and at this time, the static data required for performing the computation corresponding to the first operator may include the static data of the plurality of second operators.

In step 306, the first computational graph and the static data required for performing the computation corresponding to each first operator are serialized to obtain a model file.

In some embodiments, the first computational graph and the static data required for performing the computation corresponding to each first operator in the first computational graph may be serialized into a model file. In this way, the consumption of running time caused by respectively invoking the first computational graph and the static data corresponding to the first computational graph during operation and the running error caused by the non-correspondence between the respectively invoked first computational graph and the static data are avoided, and the running efficiency and running accuracy of the machine learning model are improved.

Various embodiments are described in this description in a progressive manner, with each embodiment focusing on differences from the other embodiments, and with reference to the same or similar parts of the various embodiments. The description is relatively simple with respect to the embodiments of the apparatus, since it substantially corresponds to the embodiments of the method, to which reference is made for a partial explanation.

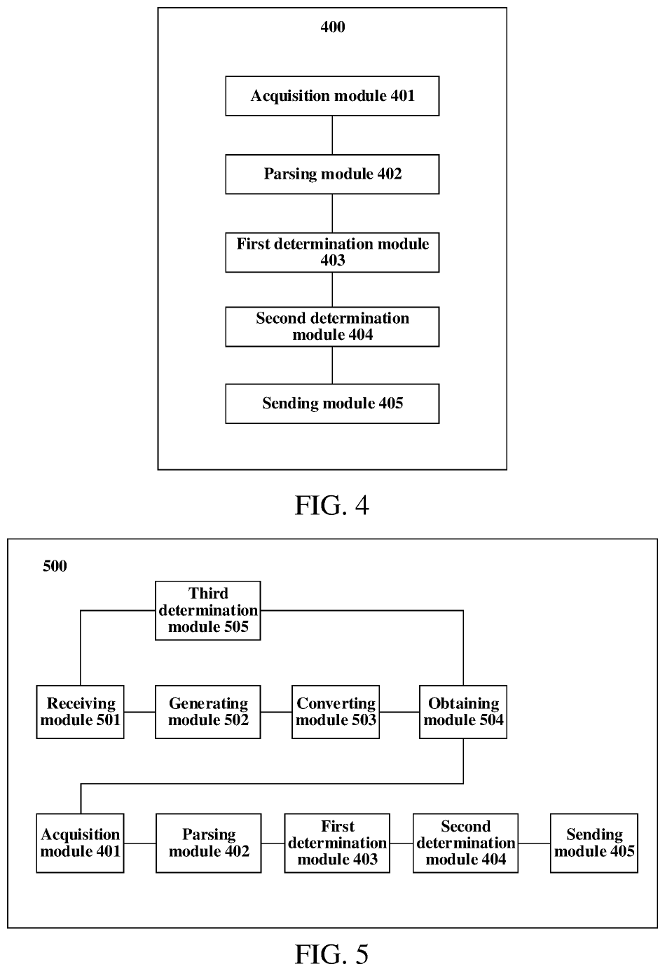

FIG. 4 is a schematic structural diagram of a model compiling apparatus according to some embodiments of the present disclosure.

As shown in FIG. 4, a model compiling apparatus 400 includes: an acquisition module 401, a parsing model 402, a first determination model 403, a second determination module 404 and a sending module 405.

The acquisition module 401 is configured to acquire a model file corresponding to a machine learning model including a plurality of computation layers in response to the running indication.

The parsing module 402 is configured to parse the model file to obtain a first computational graph executable by the hardware, the first computational graph including a plurality of first operators, each first operator corresponding to at least one computation layer.

The first determination module 403 is configured to determine the runtime information of a first set of first operators according to the input from a user and the first computational graph, the first set of first operators including at least a subset of the plurality of first operators.

The second determination module 404 is configured to determine the hardware configuration information corresponding to the first operator is determined according to the runtime information of the first operator in the first set of first operators.

The sending module 405 is configured to send the hardware configuration information corresponding to each of the plurality of first operators to a streaming-based execution device to cause the execution device to perform the computation corresponding to each first operator.

In some embodiments, the parsing module 402 may further obtain the static data required for performing the computation corresponding to each of the plurality of first operators when parsing the model file. In this case, the parsing module 402 may be further configured to determine output information of the first operator according to the input of the user, the at least one computation layer corresponding to each first operator in the first set of first operators and the static data of the first operator, the runtime information of the first operator including the output information of the first operator.

In some embodiments, the plurality of first operators may include a first set of first operators and a second set of first operators other than the first set of first operators. In these embodiments, the acquisition module 401 may be further configured to acquire hardware configuration information corresponding to each first operator in the second set of operators.

FIG. 5 is a schematic structural diagram of a model compiling apparatus according to some other embodiments of the present disclosure.

As shown in FIG. 5, in some embodiments, a model compiling apparatus 500 further includes a receiving module 501, a generating module 502, a converting module 503, and an obtaining module 504 in addition to the modules in the model compiling apparatus 400 as shown in FIG. 4.

The receiving module 501 is configured to receive structural information of the machine learning model input by the user, the structural information including types, numbers, and connection manners of the plurality of computation layers.

The generating module 502 is configured to generate a second computational graph corresponding to the machine learning model according to the structural information, where the second computational graph includes a plurality of second operators corresponding to the plurality of computation layers on a one-to-one basis.

In some embodiments, the generating module 502 may be further configured to generate in advance a computation sub-graph based on the types, numbers, and connection manners of the at least two computation layers. In this case, the second computational graph corresponding to the machine learning model generated according to the structural information input by the user may include a computation sub-graph.

The conversion module 503 is configured to convert the second computational graph into the first computational graph. In some cases, each of the plurality of first operators of the first computational graph corresponds to at least one second operator. In other cases, at least one of the plurality of first operators of the first computational graph corresponds to a plurality of second operators.

The obtaining module 504 is configured to obtain the model file according to the first computational graph.

In some embodiments, the structural information input by the user and received by the receiving module 501 may further include layer parameters for each of the plurality of computation layers. In this case, the model compiling apparatus 500 may further include a third determination module 505. The third determination module 505 is configured to determine the static data of the second operator corresponding to the computation layer according to layer parameters of each computation layer. The obtaining module 504 may further be configured to obtain the static data required for performing the computation corresponding to the first operator according to the static data of at least one second operator corresponding to each of the plurality of first operators; and serialize the first computational graph and the static data required for performing the computation corresponding to each of the plurality of first operators to obtain the model file.

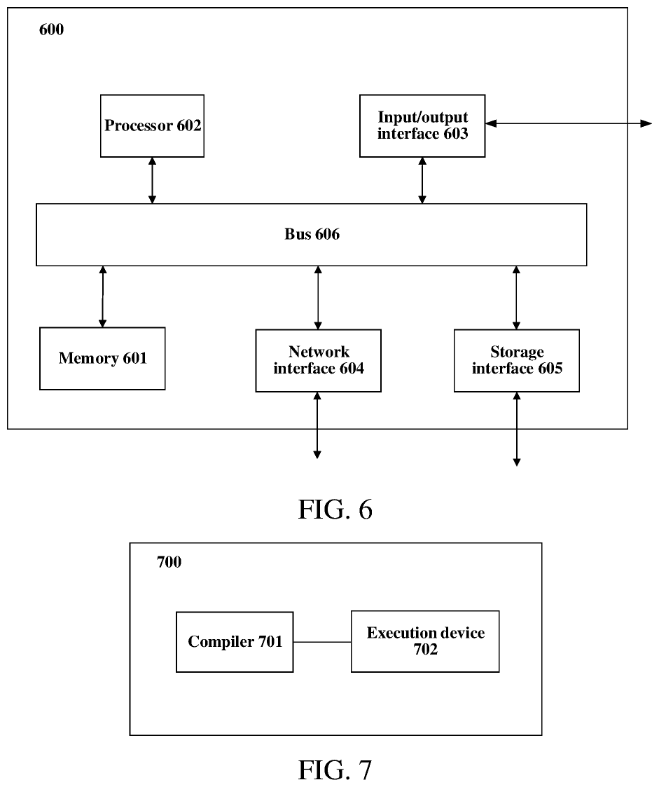

FIG. 6 is a schematic structural diagram of a model compiling apparatus according to still other embodiments of the present disclosure.

As shown in FIG. 6, a model compiling apparatus 600 includes a memory 601 and a processor 602 coupled to the memory 601. The processor 602 is configured to perform the method of any one of the above embodiments based on instructions stored in the memory 601.

The memory 601 may include, for example, a system memory, a fixed non-volatile storage medium, etc. The system memory may store, for example, a running system, application programs, boot loader programs, and other programs, etc.

The model compiling apparatus 600 may further include an input/output interface 603, a network interface 604, a storage interface 605, etc. Between the interfaces 603, 604, and 605 and between the memory 601 and the processor 602 may be connected, for example, through a bus 606. The input/output interface 603 provides a connection interface for input/output devices such as a display, a mouse, a keyboard, a touch screen, etc. The network interface 604 provides a connection interface for various networking devices. The storage interface 605 provides a connection interface for an external storage device such as an SD card, a USB disk, etc.

Embodiments of the present disclosure further provide a compiler, where the compiler includes the model compiling apparatus of any one of the above embodiments.

FIG. 7 is a schematic structural diagram of a model running system according to some embodiments of the present disclosure.

As shown in FIG. 7, a model running system 700 includes a compiler 701 and an execution device 702. The compiler 701 includes the model compiling apparatus of any one of the above embodiments, for example, the model compiling apparatuses 400/500/600. The execution device 702 is configured to perform computation corresponding to each first operator by configuring according to hardware configuration information corresponding to each of the plurality of first operators sent by the compiler 701.

Embodiments of the present disclosure further provide a computer-readable storage medium including computer program instructions which, when executed by a processor, implement the method of any one of the above embodiments.

The embodiments of the present disclosure further provide a computer program product including a computer program, where the computer program when executed by the processor implements the method of any one of the above embodiments.

So far, various embodiments of the present disclosure have been described in detail. To avoid obscuring the concepts of the present disclosure, some details known in the art are not described. According to the above description, a person skilled in the art will fully understand how to implement the technical solutions disclosed herein.

It is to be understood by a person skilled in the art that the embodiments of the present disclosure may be provided as a method, a system, or a computer program product. Accordingly, the present disclosure may take the form of an entirely hardware embodiment, an entirely software embodiment or an embodiment combining software and hardware aspects. Moreover, the present disclosure may take the form of a computer program product embodied on one or more computer-usable non-transitory storage media (including, but not limited to, magnetic disk storage, CD-ROM, optical storage and the like) having computer-usable program code embodied therein.

The present disclosure is described with reference to flow charts and/or block diagrams of methods, apparatus (systems), and computer program products according to the embodiments of the present disclosure. It is to be understood that the computer program instructions may implement specified functions in one or more flows of flow charts and/or one or more blocks of block diagrams. These computer program instructions may be provided to a processor of a general purpose computer, a special purpose computer, an embedded processor, or other programmable data processing devices to produce a machine, so that the instructions, which are executed through the processor of the computer or other programmable data processing devices, create an apparatus for implementing the specified functions in one or more flows of flow charts and/or one or more blocks of block diagrams.

These computer program instructions may also be stored in a computer-readable memory that can direct a computer or other programmable data processing devices to work in a particular manner, so that the instructions stored in the computer-readable memory produce an article of manufacture including an instruction apparatus which implements the specified functions in one or more flows of flow charts and/or one or more blocks of block diagrams.

These computer program instructions may also be loaded onto a computer or other programmable data processing devices to cause a series of operational steps to be carried out on the computer or other programmable devices to produce a process implemented by the computer so that the instructions which are executed on the computer or other programmable devices provide steps for implementing the specified functions in one or more flows of flow charts and/or one or more blocks of block diagrams.

While specific embodiments of the present disclosure have been described in detail by way of examples, it is to be understood by a person skilled in the art that the foregoing examples are only illustrative and are not intended to limit the scope of the present disclosure. It is to be understood by a person skilled in the art that changes may be made to the above embodiments or equivalents may be substituted for elements thereof without departing from the scope and spirit of the present disclosure. The scope of the present disclosure is defined by the appended claims.

1-16. (canceled)

17. A model compiling method, comprising:
acquiring a model file corresponding to a machine learning model comprising a plurality of computation layers in response to a running indication;
parsing the model file to obtain a first computational graph executable by hardware, wherein the first computational graph comprises a plurality of first operators, and each of the first operators corresponds to at least one of the computation layers;
determining runtime information of a first set of first operators according to an input from a user and the first computational graph, wherein the first set of first operators comprises at least a subset of the plurality of first operators;
determining hardware configuration information corresponding to each first operator in the first set of first operators according to the runtime information of each first operator in the first set of first operators; and
sending the hardware configuration information corresponding to each of the plurality of first operators to a streaming-based execution device, to cause the execution device to perform computation corresponding to each first operator.

18. The method according to claim 17, wherein static data required for performing the computation corresponding to each of the plurality of first operators is obtained through the parsing; and
determining runtime information of the first set of first operators according to the input from the user and the first computational graph comprises:
determining output information of each first operator in the first set of first operators according to the input, the at least one computation layer corresponding to the first operator, and the static data of the first operator, wherein the runtime information of the first operator comprises the output information of the first operator.

19. The method according to claim 17, wherein the plurality of first operators comprises the first set of first operators and a second set of first operators other than the first set of first operators, and the method further comprises:
acquiring hardware configuration information corresponding to each first operator in the second set of operators.

20. The method according to claim 17, further comprising:
receiving structural information of the machine learning model input by the user, wherein the structural information comprises types, numbers, and connection manners of the plurality of computation layers;
generating a second computational graph corresponding to the machine learning model according to the structural information, wherein the second computational graph comprises a plurality of second operators one-to-one corresponding to the plurality of computation layers;
converting the second computational graph into the first computational graph, wherein each of the plurality of first operators corresponds to at least one second operator; and
obtaining the model file according to the first computational graph.

21. The method according to claim 20, wherein the structural information further comprises layer parameters of each of the plurality of computation layers, and the method further comprises:
determining static data of the second operator corresponding to each computation layer according to the layer parameters of the computation layer; and
obtaining, according to the static data of at least one second operator corresponding to each of the plurality of first operators, static data required for performing the computation corresponding to the first operator; and
obtaining the model file according to the first computational graph comprises:
serializing the first computational graph and the static data required for performing the computation corresponding to each of the plurality of first operators to obtain the model file.

22. The method according to claim 20, wherein at least one of the plurality of first operators corresponds to a plurality of second operators.

23. The method according to claim 20, wherein the second computational graph comprises a computational sub-graph, and the computational sub-graph is generated in advance based on types, numbers, and connection manners of at least two computation layers.

24. The method according to claim 20, wherein the running indication is received via a first application programming interface, the structural information is received via a second application programming interface, and the first application programming interface and the second application programming interface are located in a same user interface.

25. The method according to claim 17, wherein the execution device comprises an artificial intelligence accelerator.

26. The method according to claim 17, wherein the machine learning model is a neural network model.

27. A model compiling apparatus, comprising:
a memory; and
a processor, coupled to the memory, and configured to perform the following steps based on instructions stored in the memory:
acquiring a model file corresponding to a machine learning model comprising a plurality of computation layers in response to a running indication;
parsing the model file to obtain a first computational graph executable by hardware, wherein the first computational graph comprises a plurality of first operators, and each first operator corresponds to at least one of the computation layers;
determining runtime information of a first set of first operators according to an input from a user and the first computational graph, wherein the first set of first operators comprises at least a subset of the plurality of first operators;
determining hardware configuration information corresponding to each first operator in the first set of first operators according to the runtime information of each first operator in the first set of first operators; and
sending the hardware configuration information corresponding to each of the plurality of first operators to a streaming-based execution device to cause the execution device to perform computation corresponding to each first operator.

28. The model compiling apparatus according to claim 27, wherein static data required for performing the computation corresponding to each of the plurality of first operators is obtained through the parsing; and
the step of determining, by the processor, the runtime information of the first set of first operators according to the input from the user and the first computational graph comprises:
determining output information of each first operator in the first set of first operators according to the input, the at least one computation layer corresponding to the first operator, and the static data of the first operator, the runtime information of the first operator comprising the output information of the first operator.

29. The model compiling apparatus according to claim 27, wherein the plurality of first operators comprise the first set of first operators and a second set of first operators other than the first set of first operators, and the processor is further configured to perform the step of:
acquiring hardware configuration information corresponding to each first operator in the second set of operators.

30. The model compiling apparatus according to claim 27, wherein the processor is further configured to perform the steps of:
receiving structural information of the machine learning model input by the user, the structural information comprising types, numbers, and connection manners of the plurality of computation layers;
generating a second computational graph corresponding to the machine learning model according to the structural information, the second computational graph comprising a plurality of second operators one-to-one corresponding to the plurality of computation layers;
converting the second computational graph into the first computational graph, each of the plurality of first operators corresponding to at least one second operator; and
obtaining the model file according to the first computational graph.

31. The model compiling apparatus according to claim 30, wherein the structural information further comprises layer parameters of each of the plurality of computation layers, and the processor is further configured to perform the step of:
determining static data of a second operator corresponding to the computation layer according to the layer parameters of each computation layer; and
obtaining static data required for performing the computation corresponding to the first operator according to the static data of at least one second operator corresponding to each of the plurality of first operators; and
the step of obtaining, by the processor, the model file according to the first computational graph comprises:
serializing the first computational graph and the static data required for performing the computation corresponding to each of the plurality of first operators to obtain the model file.

32. A model running system, comprising:
a compiler, wherein the compiler comprises the model compiling apparatus according to claim 27; and
an execution device configured to make a configuration according to hardware configuration information corresponding to each of the plurality of first operators sent by the compiler, to perform computation corresponding to each first operator.

33. The model compiling apparatus according to claim 30, wherein at least one of the plurality of first operators corresponds to a plurality of second operators.

34. The model compiling apparatus according to claim 30, wherein the second computational graph comprises a computational sub-graph, and the computational sub-graph is generated in advance based on types, numbers, and connection manners of at least two computation layers.

35. The model compiling apparatus according to claim 30, wherein the running indication is received via a first application programming interface, the structural information is received via a second application programming interface, and the first application programming interface and the second application programming interface are located in a same user interface.

36. The model running system according to claim 32, wherein the execution device comprises an artificial intelligence accelerator.
